(19) United States
(12) Patent Application Publication
(10) Pub. No.: US 2012/0077169 A1
(43) Pub. Date: Mar. 29, 2012

(54) TRACHEAL INTUBATION TRAINING MODEL AND METHOD FOR MANUFACTURING TRACHEAL INTUBATION TRAINING MODEL

(76) Inventors: Yoshimasa Takeda, Okayama (JP); Kiyoshi Morita, Okayama (JP)

(21) Appl. No.: 13/322,964

(22) PCT Filed: Jun. 1, 2010
(86) PCT No.: PCT/JP10/59244

§ 371 Date: Nov. 29, 2011

(30) Foreign Application Priority Data
Jun. 3, 2009 (JP) 2009-133825
Oct. 23, 2009 (JP) 2009-244391

(51) Int. Cl. G09B 23/30; B29C 67/00

(52) U.S. Cl. 434/267; 264/40.1

(57) ABSTRACT

Disclosed is a method for manufacturing a tracheal intubation training model with which training for securing airway by inserting an airway control device into the pharyngoesophagus can be effectively carried out. In a method for manufacturing a tracheal intubation training model for airway control training being carried out using an airway control device, an airway pharyngoesophageal area portion simulating a human airway pharyngoesophageal area which includes a pharyngoesophagus being formed in the tracheal intubation training model, the method includes: a first step where at least the pharyngoesophagus is inflated by applying an inflating pressure to the airway pharyngoesophageal area of a human body subject; a second step where the airway pharyngoesophageal area including the inflated pharyngoesophagus is imaged using an X-ray CT apparatus thus obtaining the three dimensional structure of the airway pharyngoesophageal area; and a third step where the airway pharyngoesophageal area portion is manufactured using the imaged three dimensional structure of the airway pharyngoesophageal area.

### TECHNICAL FIELD

The present invention relates to a tracheal intubation training model and a method for manufacturing a tracheal intubation training model.

### BACKGROUND OF THE INVENTION

When the breathing of a patient stops, there may be a case where an airway which is a passage through which oxygen passes is closed due to the falling of a base portion of a tongue or the like. There has been known a technique referred to as airway control where the breathing of the patient is controlled while securing the smooth flow of oxygen in the airway which is the passage through which oxygen necessary for breathing passes.

As an airway control device for securing an airway, there has been popularly used a trachea intubation tube conventionally, and the airway is secured by inserting a trachea intubation tube into a trachea from a mouth or a nose by way of a larynx.

As described above, it is often a case where such an airway control is carried out in emergencies such as stopping of breathing of the patient and hence, no failure is allowed whereby the airway control is considered as one of techniques which require constant daily training.

There has been proposed a simulation model having a trachea structure simulating an airway as a model for carrying out airway control training using a trachea intubation tube (see patent document 1, for example). A doctor, an emergency medical technician or the like who carries out airway control for a patient (hereinafter referred to as “operator”) carries out airway control training such that the operator finds a trachea inlet formed in the simulation model and inserts the trachea intubation tube through the found trachea inlet.

### PRIOR ART LITERATURE

### Patent Document

Patent document 1 JP-A-2005-227372

### SUMMARY OF THE INVENTION

### Problem that the Invention is to solve

In recent years, as the airway control device, a laryngeal mask has attracted attention since the laryngeal mask can be easily inserted into the patient and causes little pain during insertion.

In a case where the airway control is carried out using a laryngeal mask, a laryngeal mask where a small mask shaped for covering a larynx is connected to a distal end of a tube shorter than a trachea intubation tube is inserted into a pharyngoesophagus so as to cover a trachea inlet portion thus securing the airway.

With respect to such a method for securing an airway using the laryngeal mask, it is considered that the laryngeal mask can be inserted more easily than the trachea intubation tube. However, when the laryngeal mask is not properly engaged with a pharyngoesophagus including a pharyngo and an esophagus at a predetermined position thus causing a positional displacement of the laryngeal mask, there may be a case where the airway cannot be secured and air leaks from the mask engaging portion so that the expiration or the inspiration of air cannot be properly performed. After all, it is necessary for an operator to master an intubation technique, and it is necessary for him to carry out training to master the technique. However, in a simulation model described in patent document 1, a pharyngoesophagus structure is formed in a flatly-crushed shape and hence, an operator cannot insert the laryngeal mask into the pharyngoesophagus structure whereby airway control training using the laryngeal mask cannot be carried out with such a simulation model.

The present invention has been made under such circumstances, and it is an object of the present invention to provide a tracheal intubation training model with which airway control training can be carried out using an airway control device such as a laryngeal mask which is inserted into a pharyngoesophagus, and a method for manufacturing a tracheal intubation training model.

### Problems that the Invention is to solve

To achieve the above-mentioned object, according to the invention called for in claim 1, there is provided a method for manufacturing a tracheal intubation training model for airway control training being carried out using an airway control device, an airway pharyngoesophageal area portion simulating a human airway pharyngoesophageal area which includes a pharyngoesophagus being formed in the tracheal intubation training model, the method comprising: a first step where at least the pharyngoesophagus is inflated by applying an inflating pressure to the airway pharyngoesophageal area of a human body subject; a second step where the airway pharyngoesophageal area including the inflated pharyngoesophagus is imaged using an X-ray CT apparatus thus obtaining the three dimensional structure of the airway pharyngoesophageal area; and a third step where the airway pharyngoesophageal area portion is manufactured using the imaged three dimensional structure of the airway pharyngoesophageal area.

The invention called for in claim 2 is, in the method for manufacturing a tracheal intubation training model according to claim 1, characterized in that an annular recessed portion is formed in the middle of the airway pharyngoesophageal area in the third step.

The invention called for in claim 3 is, in the method for manufacturing a tracheal intubation training model according to claim 2, characterized in that the annular recessed portion is formed more largely in the lateral direction as viewed in a front view than in the depth direction as viewed in a front view.

The invention called for in claim 4 is, in the method for manufacturing a tracheal intubation training model according to any one of claims 1 to 3, characterized in that an inflating pressure in the airway pharyngoesophageal area of the subject is 5 kPa to 20 kPa.

The invention called for in claim 5 is, in the method for manufacturing a tracheal intubation training model according to any one of claims 1 to 4, characterized in that the pharyngoesophagus is inflated by hermetically sealing the inside of the airway pharyngoesophageal area of the subject by closing an oral portion and a nasal portion of the subject using a closing member, and by introducing a fluid into the inside of the airway pharyngoesophageal area of the subject from the oral portion.

The invention called for in claim 6 is, in the method for manufacturing a tracheal intubation training model according to any one of claims 1 to 5, characterized in that the three dimensional structure of the inflated airway pharyngoesophageal area is obtained using a three dimensional X-ray tomographic apparatus.

The invention called for in claim 7 is, in the method for manufacturing a tracheal intubation training model according to any one of claims 1 to 6, characterized in that in a case where the subject is a corpse, the first to third steps are performed within a period occurring 24 to 96 hours after the death of the subject.

The invention called for in claim 8 is directed to a tracheal intubation training model which is manufactured using the method for manufacturing a tracheal intubation training model according to any one of claims 1 to 7.

The invention called for in claim 9 is directed to a tracheal intubation training model for airway control training using an airway control device, an airway pharyngoesophageal area portion simulating a human airway pharyngoesophageal area which includes a pharyngoesophagus being formed in the tracheal intubation training model, wherein

an annular recessed portion is formed in the middle of the airway pharyngoesophageal area portion between a vestibular folded portion formed in a trachea inlet portion and a vocal band folded portion.

The invention called for in claim 10 is, in the tracheal intubation training model according to claim 9, characterized in that the annular recessed portion is formed more largely in the lateral direction as viewed in a front view than in the depth direction as viewed in a front view.

### Advantage of the Invention

According to one aspect of the invention called for in claim 1, the method includes: the first step where at least the pharyngoesophagus is inflated by applying the inflating pressure to the airway pharyngoesophageal area of the human body subject; the second step where the airway pharyngoesophageal area including the inflated pharyngoesophagus is imaged using an X-ray CT apparatus thus obtaining the three dimensional structure of the airway pharyngoesophageal area; and the third step where the airway pharyngoesophageal area portion is manufactured using the imaged three dimensional structure of the airway pharyngoesophageal area. Accordingly, it is possible to manufacture the tracheal intubation training model with which airway control training can be carried out using a laryngeal mask which is an airway control device of a type inserted into the pharyngoesophagus.

According to another aspect of the invention called for in claim 9, there is provided the tracheal intubation training model for airway control training using the airway control device, the airway pharyngoesophageal area portion simulating the human airway pharyngoesophageal area which includes the pharyngoesophagus being formed in a tracheal intubation training model, wherein the annular recessed portion is formed in the middle of the airway pharyngoesophageal area portion between the vestibular folded portion formed in the trachea inlet portion and the vocal band folded portion. Accordingly, in carrying out airway control training using the trachea intubation tube, an operator can carry out training for the sense of being able to avoid the recessed portion which the operator cannot visually recognize so that the operator can carry out airway control training using the trachea intubation tube under substantially the same conditions as the clinical examination.

### BRIEF DESCRIPTION OF THE DRAWINGS

FIG. 1 is a view showing the schematic constitution of a tracheal intubation training model with which airway control training is carried out.

FIG. 2 is a cross-sectional view of an airway pharyngoesophageal area portion.

FIG. 3 is a cross-sectional view taken along a line A-A in FIG. 2.

FIG. 4 is a view showing a pharyngoesophagus of a subject in a normal state.

FIG. 5 is a front view showing a mold of a three dimensional structure of an airway pharyngoesophageal area.

FIG. 6 is a side view of the mold shown in FIG. 5.

FIG. 7 is a view showing a mode for inflating the pharyngoesophagus of the subject.

FIG. 8 is a view showing a laryngeal mask.

FIG. 9 is a view showing a state where the laryngeal mask is set in the tracheal intubation training model.

FIG. 10 is a view showing a trachea intubation tube.

FIG. 11 is a view showing a larynx mirror.

FIG. 12 is a view showing a state where the larynx mirror is inserted into the tracheal intubation training model.

FIG. 13 is a view showing a trachea as viewed from above the tracheal intubation training model.

FIG. 14 is a view showing an example of failure in trachea intubation.

### MODE FOR CARRYING OUT THE INVENTION

A mode for carrying out the present invention (hereinafter, referred to as “embodiment”) is explained hereinafter. In explaining the embodiment, the explanation is made in the following order.

1. The constitution of a tracheal intubation training model 1
2. A method for manufacturing the tracheal intubation training model 1
3. A training method using the tracheal intubation training model 1

### [1. Tracheal Intubation Training Model 1]

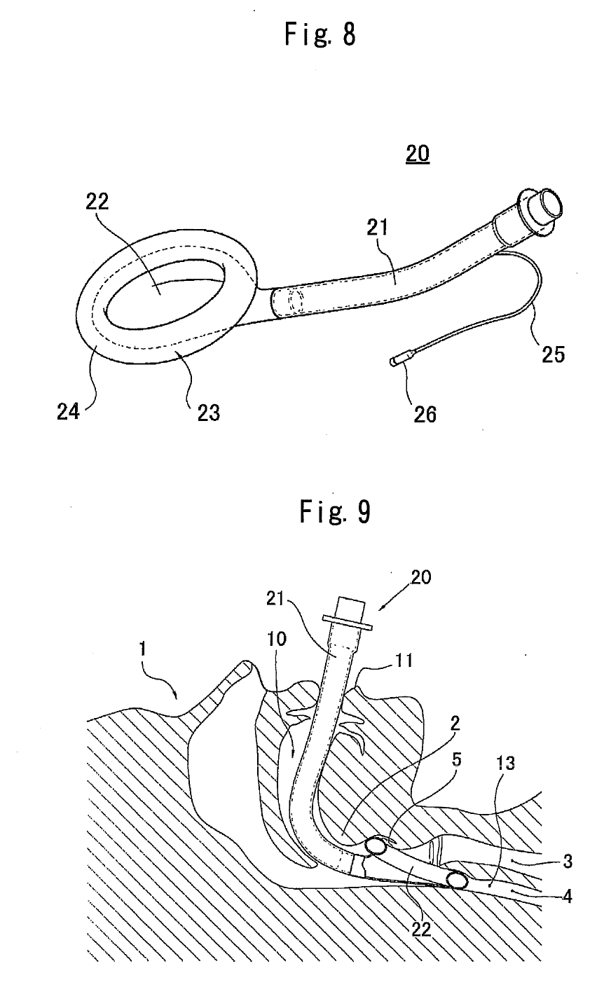

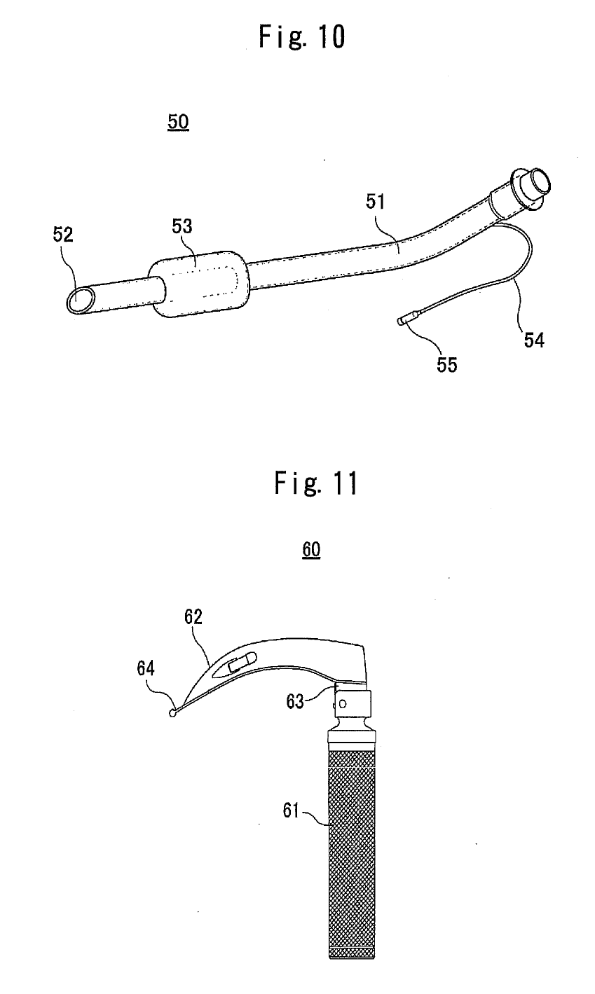

The tracheal intubation training model 1 according to this embodiment is configured to be favorably used in carrying out airway control training using a laryngeal mask 20 (see FIG. 8) or a trachea intubation tube 50 (see FIG. 10) which are described later respectively, for example.

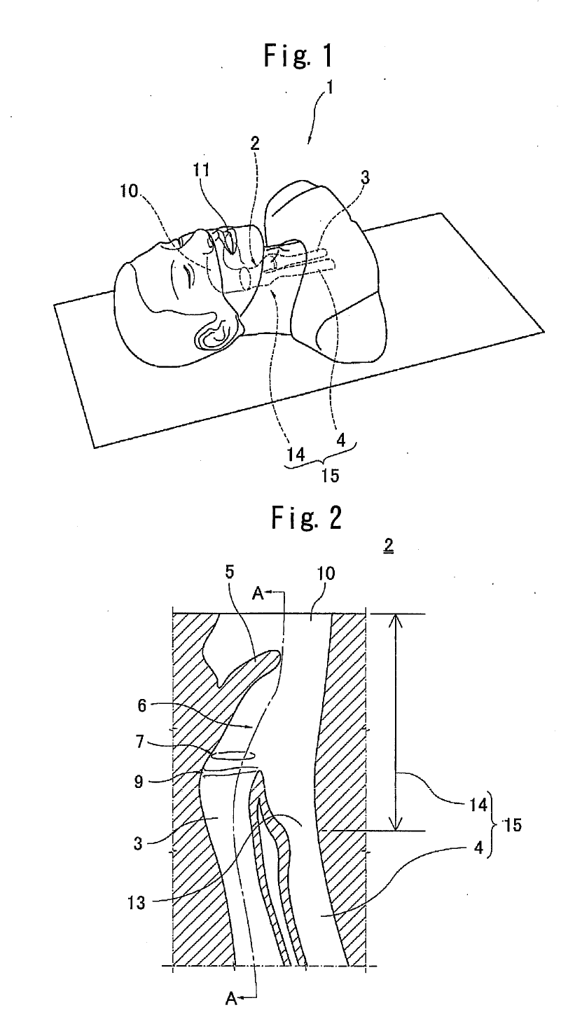

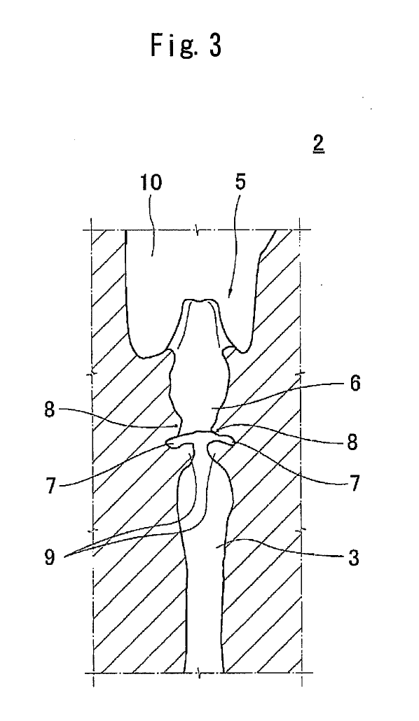

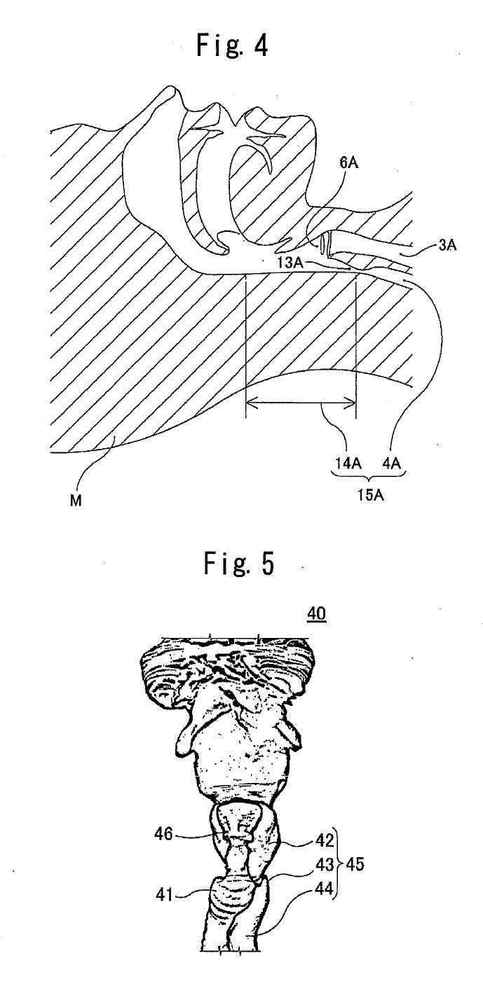

That is, as shown in FIG. 1, the tracheal intubation training model 1 has the constitution simulating an area of a human body ranging from a breast to a head. To allow an operator to carry out airway control training using an airway control device, the tracheal intubation training model 1 includes an airway pharyngoesophageal area portion 2 (see FIG. 2, FIG. 3) simulating a human airway pharyngoesophageal area which includes a pharynx 14A (see FIG. 4), a trachea 3A (see FIG. 4) and an esophagus 4A (see FIG. 4). In FIG. 1, symbol 10 indicates a buccal capsule portion, and symbol 11 indicates a labial portion.

The technical feature of the tracheal intubation training model 1 of this embodiment lies in that a pharyngoesophagus portion 15 which constitutes a part of the airway pharyngoesophageal area portion 2 is formed such that the pharyngoesophagus portion 15 is inflated more than a pharyngoesophagus 15A (see FIG. 4) of a human body except when the pharyngoesophagus 15A is in a masticatory-material swallowing state. That is, a pharynx portion 14, an esophagus inlet portion 13 and an esophagus portion 4 which constitute the pharyngoesophagus portion 15 are formed in an inflated state. The technical feature of this embodiment also lies in that a trachea portion 3 which constitutes a part of the airway pharyngoesophageal area portion 2 includes an annular recessed portion 7. Hereinafter, the airway pharyngoesophageal area portion 2 is explained with respect to respective portions.

### (Pharyngoesophagus Portion 15)

The pharyngoesophagus portion 15 is formed by simulating the pharyngoesophagus 15A of the human body, and includes the pharynx 14A and the esophagus 4A. That is, as shown in FIG. 2, the pharyngoesophagus portion 15 includes the pharynx portion 14 having the esophagus inlet portion 13, and the esophagus portion 4.

The pharynx 14A of the human body is a passage ranging from a vocal cord to a buccal capsule and a nasal cavity, and is an organ which becomes a passage for alimentary bolus only at the time of swallowing. An end portion of the pharynx 14A is connected to the esophagus 4A, and an esophagus inlet 13A is formed at a connecting portion (see FIG. 4). Further, the esophagus 4A of the human body is an organ for transferring a swallowed food to a stomach, and the esophagus 4A is positioned on the back of the trachea 3A and, at the same time, a start end portion of the esophagus 4A is connected to the pharynx 14A through the esophagus inlet 13A. The esophagus inlet 13A includes a narrowed portion (physiologically-narrowed portion). The esophagus inlet 13A is usually in an approximately closed state and, at the time of swallowing, the esophagus inlet 13A is pushed by a tongue portion thus inflated so that the esophagus inlet 13A assumes a sufficiently-open state whereby food can be pushed into the esophagus inlet 13A.

In view of the above, the pharyngoesophagus portion 15 of the tracheal intubation training model 1 is configured in the substantially same mode as the pharyngoesophagus in a pre-inflated state shown in FIG. 2 where an inflating pressure (5 kPa to 20 kPa, for example) substantially equal to a pressure applied to the pharynx 14A when a person chews and swallows food is applied to the airway pharyngoesophageal area portion 2. That is, the pharyngoesophagus portion 15 of the tracheal intubation training model 1 of this embodiment has the constitution simulating a state where the pharyngoesophagus portion 15 is in a sufficiently-open state which is substantially the same state as the pharyngoesophagus portion 15A when a person swallows food, that is, when a person swallows a material. Here, the pharyngoesophagus portion 15 including the esophagus portion 4 (tracheal intubation training model 1) is made of a resin material such as silicon rubber thus exhibiting approximate flexibility.

In the airway pharyngoesophageal area portion 2 having the above-mentioned constitution, the pharyngoesophagus portion 15 is in an open state and hence, it is possible for an operator to carry out a training for securing an airway by intubating the laryngeal mask 20 into the pharyngoesophagus portion 15. Such training has not been able to be carried out using a conventional tracheal intubation training model where a pharyngoesophagus structure is in a flatly-crushed state. That is, the tracheal intubation training model 1 of this embodiment is configured such that a doctor, an emergency medical technician or the like (hereinafter referred to as “operator”) who carries out airway control for a patient can intubate the laryngeal mask 20 described later into the pharyngoesophagus portion 15 by applying a proper pressure to the pharyngoesophagus portion 15. Accordingly, the operator can engage the laryngeal mask 20 with the pharyngoesophagus portion 15 at a predetermined position under conditions substantially equal to conditions where the operator actually carries out airway control for a patient (hereinafter referred to as “in clinical examination”) and, at the same time, the operator can carry out training for securing an airway where the operator intubates the laryngeal mask 20 into the pharyngoesophagus portion 15 with a pressure which does not damage the pharyngoesophagus portion 15.

### (Epiglottis Portion 5)

Further, an epiglottis portion 5 is a portion which is formed by simulating an epiglottis 5A (see FIG. 7) which constitutes a part of the human body. The epiglottis portion 5A moves, when a person swallows a material (at the time of swallowing), so as to cover the trachea 3A to prevent the swallowed material from entering the trachea 3A. Accordingly, the epiglottis portion 5 also exhibits sufficient flexibility so as to be able to cover a trachea inlet portion 6.

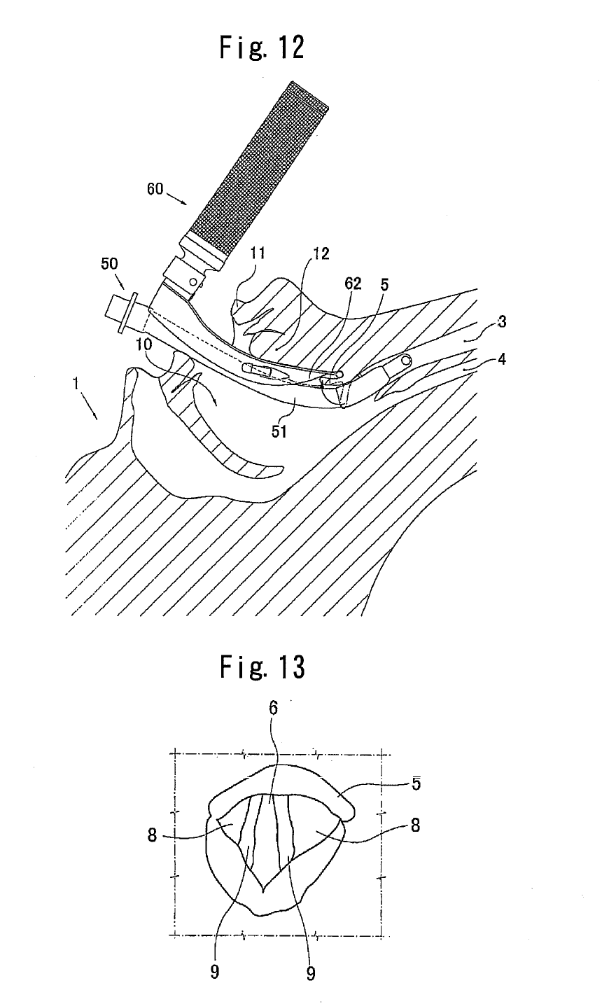

For example, in carrying out airway control training, as shown in FIG. 12, when a distal end portion of a blade 62 of a larynx mirror 60 is pressed to a base portion of the epiglottis portion 5 in a posture indicated by a chained line, the epiglottis portion 5 is lifted up thus taking a posture indicated by a solid line. Here, when the epiglottis portion 5 is lifted up, an operator can visually recognize the trachea inlet portion 6.

### (Trachea Portion 3)

The trachea portion 3 is a portion formed by simulating the trachea 3A which constitutes a part of the airway of the human body. The trachea 3A of the human body forms an air passage leading to a lung from a throat, and is a tube through which air continuously flows in and flows out from the lung. Accordingly, unlike the esophagus through which the material passes only when a person eats food, a lumen of the trachea portion 3 is usually secured.

With respect to the trachea portion 3, in this embodiment, as shown in FIG. 3, recessed portions 7, 7 each of which has an annular shape larger than the trachea portion 3 (as viewed in a front view and left and right side views respectively) are formed in the middle of the airway pharyngoesophageal area portion 2, that is, at a portion between vestibular folded portions 8 formed in the trachea inlet portion 6 and a vocal band folded portion 9.

### (Recessed Portion 7)

The recessed portions 7 are formed in the middle of the airway pharyngoesophageal area portion 2, and each of which has the annular hollow structure. The recessed portion 7 is formed more largely in the lateral direction as viewed in a front view (see FIG. 3) than in the depth direction as viewed in a front view. The description that the recessed portion 7 is formed more largely in the lateral direction as viewed in a front view than in the depth direction as viewed in a front view means that the recessed portion adopts the bag structure having an annular oval shape where, as viewed in a plan view, the lateral direction of the esophagus 4A is arranged along a long axis and the longitudinal direction of the esophagus 4A is arranged along a short axis. Further, the vestibular folded portions 8, 8 are formed directly above the recessed portions 7, 7 and hence, as shown in FIG. 13, even when the tracheal intubation training model 1 is viewed from above, the recessed portions 7, 7 are not visually recognized directly. Further, the vocal band folded portions 9, 9 are formed directly below the recessed portions 7. That is, the recessed portion 7 is formed between the vestibular folded portion 8 and the vocal band folded portion 9, and is formed of a cavity formed at a position which cannot be visually recognized from the trachea inlet portion 6, that is, at a position which cannot be visually recognized by an operator. The recessed portion 7 corresponds to a larynx chamber of the trachea 3A of the human body.

As described above, the tracheal intubation training model 1 of this embodiment includes the airway pharyngoesophageal area portion 2 having the hollow structure simulating the human airway pharyngoesophageal area including the pharynx portion 14. The pharyngoesophagus portion 15 which forms a part of the airway pharyngoesophageal area portion 2 (particularly, esophagus inlet portion 13) is formed such that the pharyngoesophagus portion 15 is sufficiently opened. The recessed portion 7 constituted of an annular cavity which is formed more largely in the lateral direction as viewed in the front view than in the depth direction as viewed in a front view is provided in the middle of the airway pharyngoesophageal area portion 2 and between the vestibular folded portion 8 formed in the trachea inlet portion 6 and the vocal band folded portion 9.

By forming the recessed portions 7, 7 having the above-mentioned constitution, the tracheal intubation training model 1 of this embodiment can be suitably used in carrying out airway control training using the trachea intubation tube 50.

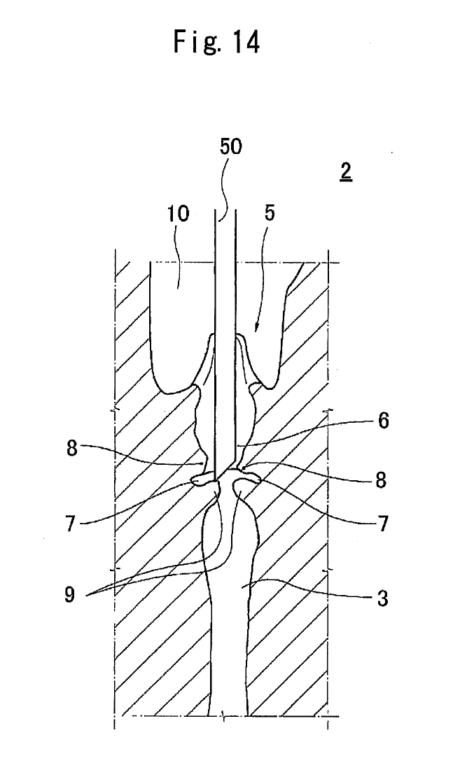

That is, although described later in detail, as shown in FIG. 14, a distal end portion of the trachea intubation tube 50 is formed into an obliquely cut shape. Accordingly, when the trachea intubation tube 50 is intubated into the trachea 3A in an actual clinical examination, the distal end portion of the trachea intubation tube 50 is liable to be caught by the larynx chamber of the human body so that there may be a case where the airway control using the trachea intubation tube 50 cannot be smoothly carried out.

In view of the above, in the tracheal intubation training model 1 of this embodiment, in substantially the same manner as an actual larynx chamber, the recessed portions 7, 7 are formed between the vestibular folded portions and the vocal band folded portion and hence, an operator can carry out airway control training using the trachea intubation tube 50 under substantially the same conditions as the clinical examination.

As has been explained heretofore, with the use of the tracheal intubation training model 1 of this embodiment, it is possible for an operator to carry out training for securing an airway by intubating the laryngeal mask 20 into a throat or training for securing an airway by intubating the trachea intubation tube 50 into the throat. This is because the pharyngoesophagus portion 15 is formed such that the pharyngoesophagus portion 15 assumes substantially the same state as the pharyngoesophagus portion 15A when a person swallows a material (in a state where the esophagus inlet portion 13 is in a open state). To bring the pharyngoesophagus portion 15 into substantially the same state as the pharyngoesophagus portion 15A when the person swallows the material, the inflating pressure of 5 kPa to 20 kPa may be applied to the airway pharyngoesophagus, for example.

Further, the recessed portions 7, 7 corresponding to the larynx chambers which an operator cannot visually recognize are formed in the tracheal intubation training model 1 of this embodiment. Accordingly, in carrying out airway control training using the trachea intubation tube 50, the operator can carry out training for the sense of being able to avoid the larynx chambers which the operator cannot visually recognize. For example, the operator can sensuously understand that, in a case where the trachea intubation tube 50 is caught by the recessed portion 7, when the operator rotates the trachea intubation tube 50 in the counterclockwise direction, the distal end of the trachea intubation tube 50 moves from a deep portion of the recessed portion 7 to a shallow portion of the recessed portion 7. Accordingly, the operator can remove the distal end of the trachea intubation tube 50 from the recessed portion 7. In this manner, even when the trachea intubation tube 50 is caught by the larynx chamber in the clinical examination, the operator who carries out airway control training using the tracheal intubation training model 1 can properly cope with such a situation and hence, the operator can rapidly secure an airway without damaging the trachea 3A of the patient.

### [2. Method for Manufacturing Tracheal Intubation Training Model 1]

A method for manufacturing the tracheal intubation training model 1 which also forms the gist this embodiment is explained hereinafter. First of all, a human body subject M is prepared. Here, as shown in FIG. 4, a larynx of the subject M is in a state where the esophagus 4A is shrunken. When the subject M is a living body, it is preferable that muscles of the pharyngoesophagus 15A are in a relaxed state under anesthesia. When the subject M is a corpse, it is preferable that 24 to 96 hours elapse after the death of the subject. The period occurring 24 to 96 hours after death is the time when postmortem rigidity of the corpse starts is loosened and the time before corruption of the corpse begins. Accordingly, it is easy to inflate the pharyngoesophagus 15A (particularly narrowed portion of the esophagus inlet 13A) so that the subject M can be preferably used in pharyngoesophagus inflating step described later.

When the subject M is prepared, as a first step, at least the pharyngoesophagus 15A is inflated by applying an inflating pressure to the airway pharyngoesophageal area of the subject M. For example, an oral portion and a nasal portion of the subject M are closed using some closing member or a hand thus hermetically sealing the airway pharyngoesophageal area of the subject M. Then, by introducing air from the oral portion, the pharyngoesophagus 15A is inflated with the inflating pressure of 5 kPa to 20 kPa which is substantially equal to a pressure applied to the pharynx 14A when a person chews and swallows food.

Next, as a second step, the three dimensional structure of the airway pharyngoesophageal area is imaged using a three dimensional X-ray CT apparatus. To be more specific, a three dimensional X-ray tomographic apparatus is used. That is, in a state where a pressure in the airway pharyngoesophageal area of the subject M is held at a predetermined pressure, the three dimensional structure of the airway pharyngoesophageal area of the subject M is imaged using a 3D-CT (computer tomographic imaging method). Due to such imaging, data on the three dimensional structure of the airway pharyngoesophageal area of the subject M can be obtained. In the data on the three dimensional structure of the airway pharyngoesophageal area, a trachea portion 41 reproduces the trachea 3A of the subject M and, in the same manner, a pharyngoesophagus portion 45 including a pharynx portion 42, an esophagus inlet portion 43 and an esophagus portion 44 reproduces the pharynx portion 14A, the esophagus 4A and the esophagus inlet 13A of the subject M, and a larynx chamber portion 46 reproduces the larynx chamber of the subject M. Further, the pharyngoesophagus portion 45 is reproduced in an inflated state.

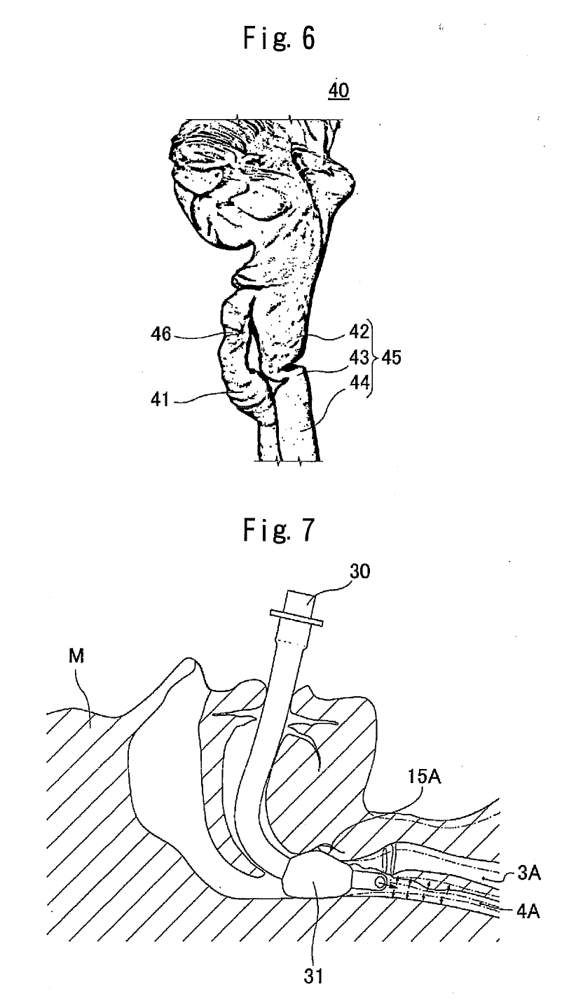

Next, in a third step, based on the data on the three dimensional structure of the airway pharyngoesophageal area obtained in the second step, a mold 40 of the tracheal intubation training model 1 shown in FIG. 5 and FIG. 6 is formed. For example, based on the data on the three dimensional structure of the airway pharyngoesophageal area obtained in the second step, a plurality of plaster pieces having a cross-sectional shape obtained by slicing the three dimensional structure of the airway pharyngoesophageal area in the horizontal direction are formed and these plaster pieces are sequentially stacked thus forming the mold 40 having a shape of the three-dimensional structure of the airway pharyngoesophageal area. In this manner, it is possible to form the mold 40 of a tracheal intubation training model having the three-dimensional structure where the larynx chamber portion 46 is provided and the pharyngoesophagus portion 45 is in an inflated state.

Then, the tracheal intubation training model 1 as shown in FIG. 1 is formed using the mold 40 formed in the third step. For example, the tracheal intubation training model 1 is formed using the mold 40 as an inner mold. To be more specific, the mold 40 is installed in an outer mold, and a molten resin material such as silicon rubber is filled into a space defined between the outer mold and the mold 40 and is cooled. Thereafter, the resin material is removed from the molds thus manufacturing the tracheal intubation training model 1 which has substantially the same surface shape and the hollow structure as the mold 40.

In the above-mentioned step 1, as another method for inflating the pharyngoesophagus 15A, as shown in FIG. 7, for example, it may be possible to inflate the pharyngoesophagus 15A of the subject M using a balloon catheter 30 in which a balloon 31 is provided to a distal end portion of the catheter 30.

The balloon catheter 30 has substantially the same constitution as the trachea intubation tube 50 described later, and by inflating the balloon 31 provided to the distal end portion of the catheter 30, the catheter 30 can be fixed at a predetermined position in the inside of the subject M. Although it is needless to say that, the balloon 31 of the balloon catheter 30 is inserted into the inside of the subject M in a shrunken state.

The balloon catheter 30 allows the balloon 31 to arrive at a predetermined position of the pharyngoesophagus 15A (for example, esophagus inlet 13A) of the subject M, and the balloon 31 is inflated. For example, the pharyngoesophagus 15A is inflated by a pressurizing means such as a pressurizing pump not shown in the drawing. Here, by monitoring an inflating pressure applied to an airway pharyngoesophagus (at least the pharyngoesophagus 15A) using a pressure gauge not shown in the drawing provided to the balloon catheter 30, the inflating pressure applied to the airway pharyngoesophagus is controlled to 5 kPa to 20 kPa.

Further, as another method for forming the mold 40, for example, there has been known a method for forming the mold 40 using a photo-setting resin. To be more specific, a container is filled with the liquid photo-setting resin, and ultraviolet laser beams which are controlled by a computer so as to obtain a desired pattern are selectively irradiated to a liquid surface of the photo-setting resin thus curing the liquid photo-setting resin of a predetermined thickness. Then, a liquid resin corresponding to an amount of one layer is supplied on the cured layer and, in the same manner as described above, the resin is cured by irradiating ultraviolet laser beams. By repeatedly performing a stacking operation for obtaining the continuous cured layers, the mold 40 having a shape of the three-dimensional structure of the airway pharyngoesophageal area is formed eventually.

As has been explained heretofore, the method for manufacturing the tracheal intubation training model 1 of this embodiment includes the first step where the inflating pressure is applied to the airway pharyngoesophageal area of the human body subject thus inflating at least the pharyngoesophagus 15A, the second step where the airway pharyngoesophageal area including the inflated pharyngoesophagus 15A is imaged using the X-ray CT apparatus thus obtaining the three dimensional structure of the airway pharyngoesophageal area, and the third step where the airway pharyngoesophageal area portion is manufactured using the imaged three dimensional structure of the airway pharyngoesophageal. Accordingly, with the use of the tracheal intubation training model 1 obtained using this manufacturing method, it is possible to carry out airway control training using the laryngeal mask 20 which is inserted into the pharyngoesophagus 15A so as to cover the larynx.

Further, the three dimensional structure of the inflated airway pharyngoesophageal area is obtained using the three dimensional X-ray tomographic apparatus and hence, it is possible to obtain the three dimensional structure of the airway pharyngoesophageal area with high accuracy.

Further, the corpse is used as the subject M, and the above-mentioned first to third steps are performed within a period occurring 24 to 96 hours after the death of the subject and hence, the corpse is in a state where postmortem rigidity of the corpse starts to be loosened and in a state before corruption of the corpse begins. Accordingly, the pharyngoesophagus 15A can be easily inflated.

Further, the realistic recessed portion 7 is formed in the three dimensional structure of the airway pharyngoesophageal area in the tracheal intubation training model 1 and hence, it is possible to carry out airway control training in a state close to the clinic examination.

That is, there has not existed the technical concept of providing the recessed portion 7 corresponding to the larynx chamber in conventional tracheal intubation training models, and the larynx chamber is ignored in the conventional tracheal intubation training model 1. Accordingly, it has been difficult to carry out airway control training using the trachea intubation tube 50 in a state close to the clinical examination. According to the method for manufacturing the tracheal intubation training model of this embodiment, however, it is possible to carry out airway control training using the laryngeal mask 20 effectively.

In this manner, according to the method for manufacturing the tracheal intubation training model of this embodiment, it is possible to obtain the tracheal intubation training model 1 with which both of airway control training using the laryngeal mask 20 and training for securing an airway by intubation using the trachea intubation tube 50 can be carried out effectively thus largely contributing to emergency medical care or the like.

In the above-mentioned method for manufacturing the tracheal intubation training model, air is used as a fluid which is introduced in inflating the pharyngoesophagus 15A in the explanation. However, the fluid may be other gases and, further, liquid or a gel-like fluid may be used as the fluid.

### [3. Training Method Using Model]

### [3.1. Training Method Using Laryngeal Mask 20]

The training method for securing airway using the tracheal intubation training model 1 having the above-mentioned constitution is explained more specifically.

Firstly, the laryngeal mask 20 is briefly explained and, then, the training method for securing airway using the laryngeal mask 20 is explained.

As shown in FIG. 8, the laryngeal mask 20 includes a flexible airway tube 21 and a cuff portion 23 which includes a ring body 24 mounted on a distal end of the airway tube 21. The cuff portion 23 includes an opening portion 22 which is gradually expanded from an airway-tube-21 side, and the ring body 24 which surrounds the opening portion 22 is formed in an expansible and shrinkable manner. That is, the ring body 24 can be inflated or can be shrunken. Further, a distal end of an inflating tube 25 is connected to the cuff portion 23, and an inflating valve 26 used for injecting a fluid such as air is provided to a proximal end portion of the inflating tube 25.

With the use of the tracheal intubation training model 1 having the above-mentioned constitution, it is possible to preferably carry out airway control training using the laryngeal mask 20 having the above-mentioned constitution.

That is, as shown in FIG. 9, the laryngeal mask 20 in a state where the ring body 24 of the cuff portion 23 is in a shrunken state is inserted into the tracheal intubation training model 1 from the labial portion 11, and the laryngeal mask 20 is engaged with the pharyngoesophagus portion 15 of the tracheal intubation training model 1 at a predetermined position (for example, esophagus inlet portion 13). Here, the pharyngoesophagus portion 15 of the tracheal intubation training model 1 is, as described above, formed such that the pharyngoesophagus portion 15 is inflated in substantially the same manner as the pharyngoesophagus 15A when a person swallows food. Accordingly, an operator can obtain feeling which has not been obtained with a conventional tracheal intubation training model, that is, feeling of inserting the laryngeal mask 20 into an actual patient. Accordingly, in the clinic examination, the operator can properly engage the laryngeal mask with a pharyngoesophagus 15A at a predetermined position thus preventing the positional displacement of the laryngeal mask whereby it is possible to secure an airway without allowing air from leaking from an engagement portion.

In inserting the laryngeal mask 20 into the patient, by bringing the laryngeal mask 20 into a state where an upper portion of the ring body 24 is engaged with the epiglottis portion 5, the laryngeal mask 20 is inserted into the patient in a state where a lower portion of the ring body 24 closes a connection portion (esophagus inlet portion 13) between the pharynx portion 14 and the esophagus portion 4 so that the opening portion 22 of the cuff portion 23 faces an inlet of the trachea portion 3 of the tracheal intubation training model 1.

Next, the ring body 24 of the cuff portion 23 is inflated by injecting air, for example, through the inflating valve 26 of the laryngeal mask 20, and the laryngeal mask 20 is fixed at the predetermined position of the pharyngoesophagus portion 15. The pharyngoesophagus portion 15 of the tracheal intubation training model 1 is formed such that the pharyngoesophagus portion 15 is inflated and hence, also in inflating the ring body 24, the operator can obtain feeling of inflating the cuff portion 23 with respect to an actual patient. Accordingly, the operator can sensuously understand a proper amount of air which is injected in the cuff portion 23 so that it is possible to suppress the injection of an excessive amount of air into the cuff portion 23 in the clinic examination thus preventing the pharyngoesophagus 15A or the like of the patient from being damaged.

By performing the above-mentioned operations, the trachea portion 3 of the tracheal intubation training model 1 is communicably connected to the outside of the tracheal intubation training model 1 by way of the opening portion 22 of the laryngeal mask 20 and the airway tube 21. In this manner, the simulation of securing an airway of the patient is carried out. Further, by carrying out airway control training using the tracheal intubation training model 1 which has the structure where the pharyngoesophagus portion 15 is inflated, it is possible to carry out airway control training using the laryngeal mask 20.

As has been explained heretofore, according to the tracheal intubation training model 1 of this embodiment, the esophagus portion 4 is formed such that the esophagus portion 4 is inflated in substantially the same manner as the esophagus 4A when a person swallows food and hence, the operator can insert the laryngeal mask 20 into the pharynx portion 14 without any difficulty. Due to such a constitution, the operator can freely carry out airway control training using the laryngeal mask 20 at any time. Particularly, the pharyngoesophagus portion 15 is formed such that the pharyngoesophagus portion 15 is inflated in substantially the same manner as the pharyngoesophagus 15A when a person swallows food and hence, the operator can carry out training for securing the airway by inserting the laryngeal mask 20 under substantially the same conditions as the clinical examination. Accordingly, in the clinic examination, the operator can carry out the airway control smoothly with confidence.

### [3.2 Training Method for Securing Airway Using Trachea Intubation Tube 50]

Next, a training method for securing an airway by trachea intubation is explained. The trachea intubation is a method for securing the airway by inserting the trachea intubation tube 50 into the trachea 3A from a mouth or a nose through the larynx. Firstly, the trachea intubation tube 50 which is used in the training method is briefly explained.

In the trachea intubation tube 50, as shown in FIG. 10, a distal end side of an airway tube 51 through which air passes is obliquely cut thus forming a tapered opening portion 52, and a cuff portion 53 is formed at a position slightly behind the opening portion 52 so as to surround the airway tube 51. In the same manner as the cuff portion 23 of the above-mentioned laryngeal mask 20, the cuff portion 53 is formed in an expansible and shrinkable manner and, at the same time, a distal end of an inflating tube 54 is connected to the cuff portion 53. Further, an inflating valve 55 for injecting a fluid such as air is provided to a proximal end portion of the inflating tube 54.

As shown in FIG. 11, the larynx mirror 60 is constituted of a grippable columnar handle 61 and a blade 62 which is connected to the handle 61, and the handle 61 has an approximately columnar shape. The blade 62 is connected to an upper end portion of the handle 61 by way of a recessed connection portion formed in the handle not shown in the drawing.

The blade 62 is a portion which is inserted into the larynx from a mouth of the patient, and has an approximately arcuate shape such that the blade 62 is gently curved in an upward convex shape and the blade 62 extends from a proximal portion 63 to the distal end portion 64 as viewed in a side view. The distal end portion 64 of the blade 62 is a portion which is firstly inserted into the mouth of the patient. For facilitating the insertion of the blade 62 into the mouth of the patient, the distal end portion 64 of the blade 62 has a shape which has a narrow width in the vertical direction and extends by a predetermined length in the lateral direction as viewed in a front view. Further, a distal end of the blade 62 has a slightly rounded shape for preventing the blade 62 from damaging the larynx of the patient.

With the use of the tracheal intubation training model 1 having the above-mentioned constitution, it is possible for an operator to carry out airway control training using the trachea intubation tube 50 having the above-mentioned constitution.

That is, as shown in FIG. 12, in a state where the distal end portion 64 of the blade 62 of the larynx mirror 60 is inserted into the tracheal intubation training model 1 from the labial portion 11 of the model 1 along a tongue portion 12, the tongue portion 12 is lifted upwardly by lifting up the blade 62 and, thereafter, the trachea intubation tube 50 is inserted into the model 1 from the labial portion 11 thus inserting the opening portion 52 of the trachea intubation tube 50 to the trachea portion 3.

Here, as in the case of the larynx chamber portion 46 formed in the mold 40 shown in FIG. 5 and FIG. 6, in the larynx of the human body, a larynx chamber is present below a trachea inlet 6A (see FIG. 4). As can be understood from FIG. 13, however, it is difficult for an operator to visually recognize the larynx chamber from above. Further, the distal end of the trachea intubation tube 50 which is used in the trachea intubation is formed into a tapered shape. Accordingly, there may be a case where the trachea intubation tube 50 is caught by the larynx chamber in the clinic examination.

In the case where the distal end of the trachea intubation tube 50 is caught by the larynx chamber (see FIG. 14), since it is difficult for an operator to visually recognize the larynx chamber, there may be a case where the operator cannot recognize a state where the distal end of the trachea intubation tube 50 is caught by the larynx chamber. As another case, even when the operator recognizes the state where the distal end of the trachea intubation tube 50 is caught by the larynx chamber, there may be a case where the operator cannot perform a treatment (a treatment to rotate the trachea intubation tube 50 in the counterclockwise direction, for example) skillfully to cope with the such a state. In preparation for such an actual clinic examination, training using the tracheal intubation training model 1 according to this embodiment becomes effective.

In airway control training using the trachea intubation tube 50 according to this embodiment, the operator largely opens the labial portion 11 of the tracheal intubation training model 1 using the larynx mirror 60, and inserts the trachea intubation tube 50 aiming at the trachea inlet portion 6 while watching the trachea inlet portion 6 (see FIG. 13) from the buccal capsule portion 10. Here, the recessed portions 7 which cannot be visually recognized from the outside are formed in the trachea portion 3 of the tracheal intubation training model 1 and hence, depending on an angle at which the trachea intubation tube 50 is intubated, as shown in FIG. 14, there may be a case where the trachea intubation tube 50 is caught by the recessed portion 7. The operator can experience that when the trachea intubation tube 50 is caught by the recessed portion 7, by moving the distal end of the trachea intubation tube 50 from the deep portion of the recessed portion 7 to the shallow portion of the recessed portion 7 by rotating the trachea intubation tube 50 in the counterclockwise direction, the trachea intubation tube 50 is removed from the recessed portion 7 and is intubated into the model 1. Accordingly, by carrying out training using the tracheal intubation training model 1, the operator can naturally acquire a technique for intubating the trachea intubation tube 50 while avoiding the recessed portions 7 so that the operator can improve an intubation technique.

That is, the vestibular folded portions 8 are formed directly above the recessed portions 7 and hence, as shown in FIG. 13, the recessed portions 7 cannot be visually recognized from above the tracheal intubation training model 1 directly. Due to such a constitution, the operator can carry out training for securing the airway while sensuously avoiding the recessed portions 7, or while removing the trachea intubation tube 50 caught by the recessed portion 7. In this manner, according to the tracheal intubation training model 1 of this embodiment, the annular recessed portions 7 are formed in the middle of the airway pharyngoesophageal area portion 2 and hence, the operator can carry out airway control training under substantially the same conditions as the clinical examination.

After the trachea intubation tube 50 is intubated into the model 1, the trachea intubation tube 50 is fixed at a predetermined position of the trachea portion 3 by inflating the cuff portion 53 by injecting air from the inflating valve 55.

By performing the above-mentioned operations, the trachea portion 3 of the tracheal intubation training model 1 is communicably connected to the outside of the tracheal intubation training model 1 by way of the opening portion 52 of the trachea intubation tube 50 and the airway tube 51. In this manner, the simulation of securing an airway of the patient is carried out.

As has been explained heretofore, in a conventional simulation model (see patent document 1), a trachea structure of the simulation model is formed into a flat shape and hence, in carrying out airway control training, there is no possibility that the trachea intubation tube 50 is caught by a portion corresponding to the larynx chamber. That is, with the use of the conventional simulation model, although training for finding the trachea inlet portion from above the simulation model and inserting the trachea intubation tube 50 toward the found-out trachea inlet portion can be carried out, training for securing an airway simulating the larynx chamber cannot be carried out.

Accordingly, even when the operator can smoothly carry out the simulation of securing the airway in the training, there may be a case where the operator cannot necessarily avoid the larynx chamber skillfully in the actual clinic examination. Further, when the trachea intubation tube 50 is caught by the larynx chamber, since the operator is not accustomed to removing the trachea intubation tube 50 from the larynx chamber, there may be a case where the operator cannot secure the airway smoothly due to nervousness and impatience. However, if the operator carries out training using the tracheal intubation training model 1 of this embodiment in advance, even when the trachea intubation tube 50 is caught by the larynx chamber, the operator can perform a proper treatment.

Although the present invention has been explained in conjunction with embodiment, the present invention is not limited to the embodiment, and various modifications are conceivable. For example, although the explanation has been made with respect to the case where air is used as the fluid which is introduced for inflating the pharyngoesophagus 15A, the fluid may be other gases and, further, liquid or a gel-like fluid may be used as the fluid.

Further, in this embodiment, the annular recessed portions 7, 7 are formed on the trachea portion 3 of the airway pharyngoesophageal area portion 2. When airway control training using the trachea intubation tube 50 is not carried out, it is not always necessary to form the recessed portions 7, 7 on the trachea portion 3.

### DESCRIPTION OF REFERENCE NUMERALS AND SIGNS

1: tracheal intubation training model
2: airway pharyngoesophageal area portion
3, 41: trachea portion
4, 44: esophagus portion
14, 42: pharynx portion
5: epiglottis portion
6: trachea inlet portion
7: recessed portion
8: vestibular folded portion
9: vocal band folded portion
10: buccal capsule portion
11: labial portion
12: tongue portion
13, 43: esophagus inlet portion
15, 45: pharyngoesophagus portion
20: laryngeal mask
21, 51: airway tube
22, 52: opening portion of airway tube
23, 53: cuff portion
24: ring body
25, 54: inflating tube
26, 55: inflating valve
30: balloon catheter
31: balloon
40: mold
46: larynx chamber portion
50: trachea intubation tube
60: larynx mirror
61: handle
62: blade
63: proximal portion of blade
64: distal end portion of blade
M: subject

1.-10. (canceled)

11. A tracheal intubation training model, for airway control training, comprising:
an airway control device; and
an airway pharyngoesophageal area portion simulating a human airway pharyngoesophageal area which includes a pharyngoesophagus being formed in the tracheal intubation training model;
wherein an annular recessed portion is formed in the middle of the airway pharyngoesophageal area portion between a vestibular folded portion formed in a trachea inlet portion and a vocal band folded portion.

12. The tracheal intubation training model, according to claim 11, wherein:
the annular recessed portion is formed more largely in the lateral direction as viewed in a front view than in the depth direction as viewed in a front view.

13. A method for manufacturing the tracheal intubation training model, comprising the steps of:
providing an airway control device;
providing an airway pharyngoesophageal area portion simulating a human airway pharyngoesophageal area which includes a pharyngoesophagus being formed in the tracheal intubation training model;
wherein an annular recessed portion is formed in the middle of the airway pharyngoesophageal area portion between a vestibular folded portion formed in a trachea inlet portion and a vocal band folded portion;
a first step where at least the pharyngoesophagus is inflated by applying an inflating pressure to the airway pharyngoesophageal area of a human body subject;
a second step where the airway pharyngoesophageal area including the inflated pharyngoesophagus is imaged using an X-ray CT apparatus and obtaining a three dimensional structure of the airway pharyngoesophageal area; and
a third step where the airway pharyngoesophageal area portion is manufactured using the imaged three dimensional structure of the airway pharyngoesophageal area.

14. The method for manufacturing a tracheal intubation training model, according to claim 13, wherein:
the annular recessed portion is formed in the third step.

15. The method for manufacturing a tracheal intubation training model, according to claim 13, wherein:
an inflating pressure provided in the airway pharyngoesophageal area of the subject is 5 kPa to 20 kPa.

16. The method for manufacturing a tracheal intubation training model, according to claim 13, wherein:
the pharyngoesophagus is inflated by hermetically sealing the inside of the airway pharyngoesophageal area of the subject by closing an oral portion and a nasal portion of the subject using a closing member and by introducing a fluid into the inside of the airway pharyngoesophageal area of the subject from the oral portion.

17. The method for manufacturing a tracheal intubation training model, according to claim 13, wherein:
the three dimensional structure of the inflated airway pharyngoesophageal area is obtained using a three dimensional X-ray tomographic apparatus.

18. The method for manufacturing a tracheal intubation training model, according to claim 13, wherein:
in a case where the subject is a corpse, the first to third steps are performed within a period occurring 24 to 96 hours after a death of the subject.

19. A method for manufacturing the tracheal intubation training model, comprising the steps of:
providing an airway control device;
providing an airway pharyngoesophageal area portion simulating a human airway pharyngoesophageal area which includes a pharyngoesophagus being formed in the tracheal intubation training model;
wherein, an annular recessed portion is formed in the middle of the airway pharyngoesophageal area portion between a vestibular folded portion formed in a trachea inlet portion and a vocal band folded portion;
wherein, the annular recessed portion is formed more largely in the lateral direction as viewed in a front view than in the depth direction as viewed in a front view;
a first step where at least the pharyngoesophagus is inflated by applying an inflating pressure to the airway pharyngoesophageal area of a human body subject;
a second step where the airway pharyngoesophageal area including the inflated pharyngoesophagus is imaged using an X-ray CT apparatus and obtaining a three dimensional structure of the airway pharyngoesophageal area; and
a third step where the airway pharyngoesophageal area portion is manufactured using the imaged three dimensional structure of the airway pharyngoesophageal area.

20. The method for manufacturing a tracheal intubation training model, according to claim 19, wherein:
the annular recessed portion is formed in the third step.

21. The method for manufacturing a tracheal intubation training model, according to claim 19, wherein:
an inflating pressure provided in the airway pharyngoesophageal area of the subject is 5 kPa to 20 kPa.

22. The method for manufacturing a tracheal intubation training model, according to claim 19, wherein:
the pharyngoesophagus is inflated by hermetically sealing the inside of the airway pharyngoesophageal area of the subject by closing an oral portion and a nasal portion of the subject using a closing member and by introducing a fluid into the inside of the airway pharyngoesophageal area of the subject from the oral portion.

23. The method for manufacturing a tracheal intubation training model, according to claim 19, wherein:
the three dimensional structure of the inflated airway pharyngoesophageal area is obtained using a three dimensional X-ray tomographic apparatus.

24. The method for manufacturing a tracheal intubation training model, according to claim 19, wherein: [symbol]
